(19) United States
(12) Patent Application Publication
(10) Pub. No.: US 2008/0257175 A1
(43) Pub. Date: Oct. 23, 2008

(54) Fluid injection for liquid extraction

(76) Inventors: Benjamin Wayne Floan, Andover, MN (US); Lon E. Smallridge, West Des Moines, IA (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/528,204

(22) Filed: Sep. 27, 2006

Related U.S. Application Data
(60) Provisional application No. 60/720,903, filed on Sep. 27, 2005.

(51) Int. Cl. B30B 15/30

(52) U.S. Cl. 100/73

(57) ABSTRACT

Injectors and injection rings for injecting fluid into a screw press are disclosed. More particularly, systems and methods of reliably injecting fluid into an extraction press on a controllable basis are contemplated along with supporting technology.

### RELATED APPLICATIONS

This application claims priority to U.S. Provisional Application No. 60/720,903, entitled “Solvent Injection Apparatus for High Pressure Liquid Extraction,” filed Sep. 27, 2005, which is incorporated herein by reference.

### TECHNICAL FIELD

The present invention relates to liquid extraction processes, and related equipment for the extraction of liquid from a liquid-bearing material comprising solids, more particularly, a continuous fluid extraction methodology employing a screw press into which a material bearing an extractable component is fed, and a fluid (e.g., carbon dioxide or an alcohol) is employed as a solvent in furtherance of producing an extracted liquid and a solid product having a reduced liquid content. Further still, an aspect of the subject invention relates to a fluid injection apparatus for a screw press or the like for carrying out the inventive process and/or enhancing extractions of heretofore known fluid extraction processes.

### BACKGROUND OF THE INVENTION

Screw presses for, and methods of expelling liquids from liquid bearing material/solids is well known and disclosed in U.S. Pat. Nos. 5,939,571 (Foidl), 4,901,635 (Williams), 4,357,865 (Knuth et al.), 4,744,926 (Rice), and 3,607,391 (Shann), each of which is incorporated herein by reference. Furthermore, there are numerous teachings directed to the extraction of oil from oil bearing seeds/fruits, e.g., U.S. Pat. Nos. 4,675,133 (Eggers et al.), 4,683,063 (Rice), 4,877,530 (Moses), 4,770,780 (Moses), 5,041,245 (Benado), 5,169,968 (Rice), 5,290,959 (Rice), and U.S. Pat. Appl. Publ. Pub. No. US 2004/0146627A1, incorporated herein by reference, as well as, well known processes published by Soyatech, Inc. (soyatech.com), “2005 Soya & Oilseed Bluebook” (Soyatech, Inc.), which is likewise incorporated herein by reference.

One application of such technologies is in the recovery of defatted soybean solids and soybean oil from soybeans. Raw, dehulled soybeans, for example, generally comprise 18% oil, 15% soluble carbohydrates, 15% insoluble carbohydrates, 14% moisture and ash, and 38% protein. Edible defatted flakes, an intermediate of bean processing, are the basis of all soy protein products, namely, flour, isolates, and concentrates. Commercially, edible defatted flakes typically result from continuous solvent extraction using hexane, with subsequent desolventizing via toasting, see e.g., FIG. 1, U.S. Pat. Appl. No. US 2004/0146627A1. In addition to continuous hexane extraction, limited batch extraction methods are know, utilizing a variety of solvents, for producing edible defatted flakes. In light of heretofore know extraction methodologies, it remains advantageous to eliminate/consolidate processing steps, reduce energy consumption, and produce a flake/cake suitable for human consumption via a high pressure liquid extraction. Furthermore, it is desirable to provide an apparatus conducive to such high pressure liquid extraction, namely, a screw press apparatus for facilitating fractionation of liquid from liquid bearing material fed thereto and processed thereby.

### BRIEF DESCRIPTION

A continuous high pressure liquid extraction process is contemplated, more particularly, a process utilizing a screw press for directly processing liquid bearing solids (e.g., oliferous seeds/vegetation for oil extraction/expression and edible defatted flake/cake production, petroleum bearing solids for recovery of hydrocarbon), and/or intermediates thereof (e.g., edible defatted flakes in furtherance of producing concentrate/isolates thereof). In some embodiments of the invention, the screw press may be characterized by a ring of circumferentially spaced apart fluid injectors in one or more extraction zones thereof. The injectors, and their configuration within the fluid injection apparatus permit heretofore unseen process control and press maintenance.

Heretofore known pressing devices utilizing high pressure liquid extraction have consistently plugged, that is to say, the nozzles that feed fluid to the press have a greatly reduced functionality as a function of time, owing to the one or more fluid delivering nozzles filling with material fed into the press. Nozzle plugging issues are even more likely in the event that fluid injection is interrupted, either intentionally or as a result of a malfunction, while the press continued operating.

One embodiment in accordance with the invention includes an apparatus having a screw press with a shaft and cage. In this embodiment an injector is used for injecting fluid into the press. The injector has a mechanical limiter that opens to allow fluid through the injector when a fluid supply pressure to the injector exceeds a first threshold level and closes when the fluid supply pressure to the injector is below a second threshold level. Such an injector may open and close at essentially the same pressure or the injector may open at one pressure and remain open until the supply pressure drops below a lower threshold pressure.

In another embodiment in accordance with the invention, an apparatus having a screw press with a shaft and cage is disclosed. In this embodiment an injector is used for injecting fluid into the press. The injector has a mechanical limiter that opens to allow fluid through the injector when a fluid supply pressure to the injector exceeds a first threshold level and closes when the fluid supply pressure to the injector is below a second threshold level. In this embodiment the injector is installed in an injection ring. The injection ring may replace a section of the cage of the screw press and be essentially coextensive with the cage while providing for the installation of an injector. In some embodiments more than one injector may be installed in the injection ring. For example, four or six injectors may be used. The injectors may be arranged in an equidistant arrangement around the ring or other arrangement as may be beneficial when considering operational efficiency and ease of access for installation, maintenance and replacement.

In yet another embodiment in accordance with the invention, an apparatus having a screw press with a shaft and cage is disclosed. In this embodiment an injector is used for injecting fluid into the press. The injector has a mechanical limiter that opens to allow fluid through the injector when a fluid supply pressure to the injector exceeds a first threshold level and closes when the fluid supply pressure to the injector is below a second threshold level. In this embodiment the screw press has at least one extraction zone and the injector is configured to inject fluid into the reaction zone.

In yet another embodiment in accordance with the invention, an apparatus having a screw press with a shaft and cage is disclosed. In this embodiment an injector is used for injecting fluid into the press. The injector has a mechanical limiter that opens to allow fluid through the injector when a fluid supply pressure to the injector exceeds a first threshold level and closes when the fluid supply pressure to the injector is below a second threshold level. The fluid in this embodiment may comprise a coolant. In some embodiments, heat developed in the extraction process can have a detrimental effect on the products passing through the press. The injection of a coolant can mitigate these effects. The fluid may alternatively be a solvent or solute that aids in the separation of the fluid of interest from the material that is fed to the press. The fluid may also act to mechanically aid separation, such as by vaporizing within the press after infiltrating the products or by being injected at a velocity that affects the product passing through the press. A single fluid may have one or more of these characteristics. For example, a fluid may be injected that acts as both a coolant and a solvent, or even as a coolant, solvent, and mechanical aid to separation among other functions. The fluid may be injected at any conditions appropriate for the particular application, including supercritical or near-supercritical.

In yet another embodiment in accordance with the invention, an apparatus having a screw press with a shaft and cage is disclosed. In this embodiment an injector is used for injecting fluid into the press. The injector has a mechanical limiter that opens to allow fluid through the injector when a fluid supply pressure to the injector exceeds a first threshold level and closes when the fluid supply pressure to the injector is below a second threshold level. In this embodiment, the injector has a conduit for passing fluid through and the cross-sectional area of the conduit is selected to provide for a predetermined volumetric flow rate of fluid at a predetermined fluid supply pressure.

In another embodiment in accordance with the invention, a screw press having a shaft and cage is disclosed. This embodiment includes an injector for injecting fluid into the press, the injector comprising an electrically operated actuator that opens to allow fluid through the injector and closes to restrict fluid flow through the injector. In some embodiments, the actuator may be biased to reset to a closed position in the absence of an electrical signal.

In another embodiment in accordance with the invention, a screw press having a shaft and cage is disclosed. This embodiment includes an injector for injecting fluid into the press, the injector comprising an electrically operated actuator that opens to allow fluid through the injector and closes to restrict fluid flow through the injector. In this embodiment the flow rate through the injector may be regulated by a digital control system that adjusts the frequency that the actuator opens and closes.

In another embodiment in accordance with the invention, a screw press having a shaft and cage is disclosed. This embodiment includes an injector for injecting fluid into the press, the injector comprising an electrically operated actuator that opens to allow fluid through the injector and closes to restrict fluid flow through the injector. In this embodiment the flow rate through the injector is regulated by a digital control system that adjusts the duration that the actuator is open and closed.

In another embodiment in accordance with the invention, a system for extracting oil from oil-bearing solids including a screw press having a shaft and cage is disclosed. This embodiment includes at least two injectors for injecting fluid into the press. The injectors of this embodiment have mechanical limiters that open to allow fluid through each injector when a fluid supply pressure to the injector exceeds a first threshold level and closes when the fluid supply pressure to the injector is below a second threshold level. The system of this embodiment also includes a fluid supply tank for supplying a fluid to the injectors, fluid supply lines to each injector, and a valve in each of the supply lines.

In another embodiment in accordance with the invention, a system for extracting oil from oil-bearing solids including a screw press having a shaft and cage is disclosed. This embodiment includes at least two injectors for injecting fluid into the press. The injectors of this embodiment have mechanical limiters that open to allow fluid through each injector when a fluid supply pressure to the injector exceeds a first threshold level and closes when the fluid supply pressure to the injector is below a second threshold level. The system of this embodiment also includes a fluid supply tank for supplying a fluid to the injectors, fluid supply lines to each injector, and a valve in each of the supply lines. In this embodiment the valves are automatic valves and the system includes a controller for opening and closing the valves to regulate fluid flow to the press.

In yet another embodiment in accordance with the invention, a system for extracting oil from oil-bearing solids including a screw press having a shaft and cage is disclosed. This embodiment includes at least two injectors for injecting fluid into the press. The injectors of this embodiment have mechanical limiters that open to allow fluid through each injector when a fluid supply pressure to the injector exceeds a first threshold level and closes when the fluid supply pressure to the injector is below a second threshold level. The system of this embodiment also includes a fluid supply tank for supplying a fluid to the injectors, fluid supply lines to each injector, and a valve in each of the supply lines. In this embodiment the valves are automatic valves and the system includes a controller for opening and closing the valves to regulate fluid flow to the press. In this system at least one injector is positioned to inject fluid in one zone of the press and at least one other injector is positioned to inject fluid in a different zone of the press, and the controller opens and closes valves to regulate fluid flow to these zones independently of one another.

### BRIEF DESCRIPTION OF THE DRAWINGS

FIG. 1 is a side cross-section view of an injector in accordance with embodiments of the invention;

FIG. 2 is a schematic of a system in accordance with embodiments of the invention;

FIG. 3 is a cross section of a injection ring in accordance with embodiments of the invention;

FIG. 4 is a cross section of a injection ring in accordance with embodiments of the invention;

FIG. 5 is a schematic of a system in accordance with embodiments of the invention.

### DETAILED DESCRIPTION

Embodiments in accordance with the invention will now be described with reference to the Figures. Similar elements will be assigned similar reference numbers on each Figure. The Figures are exemplary only and do not limit the scope of the invention in any way.

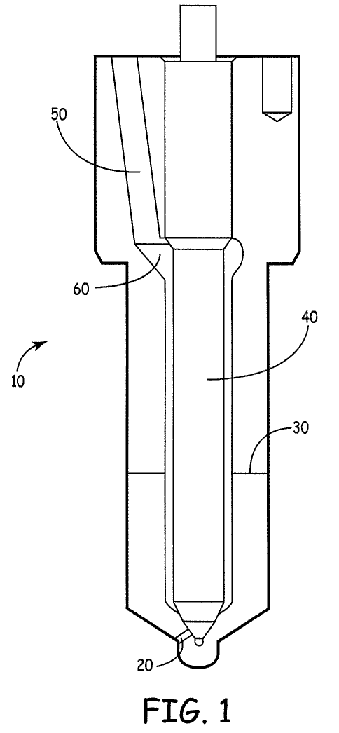

FIG. 1 is a side cross-section view of an injector in accordance with embodiments of the invention. The injector 10 of FIG. 1 includes a conduit 20 that passes through an injector body 30. An actuator 40 may be used to selectively allow fluid flow through the conduit 20 or restrict fluid flow. The embodiment of FIG. 1 includes a threaded portion (not shown) for securing the injector to the press or injection ring and a coupling (not shown) for attaching a fluid supply line. In the embodiment shown in FIG. 1, fluid from the fluid supply line is supplied to the injector feed line 50. The fluid fills the actuator chamber 60. When the fluid in the actuator chamber 60 exceeds a threshold pressure, the fluid pressure acts to move the actuator upward and allow fluid from the injector feed line to pass to the conduit 20. The fluid exits the injector through the conduit 20. Injectors in accordance with the invention may be configured in a variety of ways and with a variety or numbers and orientations of conduits from which the fluid is expelled from the injector. Exemplary injectors that may be used in embodiments of the invention include Bosch® Models KDAL59P6 or KDAL59P7 or the like Those of skill in the art will be familiar with injectors that are useful in these applications.

The injector 10 may be of a mechanical type, meaning that when a specific pressure is reached in the supply line the injector opens. If the supply pressure falls below a threshold pressure, the injector closes. This feature helps prevent material being pressed from plugging the holes that feed the fluid into the press, especially when the fluid supply system is shut off, in stand by, or interrupted for some reason.

In some embodiments custom injectors 10 having specified conduit 20 cross-sectional area may be used. Since the area is related to the volumetric flow at a specific pressure, rough control of fluid volume injected into the press may be effected by selecting an appropriate conduit 20 size. If more than one injector 10 is used, distribution of fluid between the injectors can also be impacted by selection of appropriate relative conduit 20 cross-sections.

Injector 10 may alternatively be electronically actuated. Electronically actuated injectors may provide greatly improved, and arguably, complete control over injection fluid injection volume because they can be activated independently of fluid supply pressure. Fluid flow volume through the injector 10 may be easily and quickly adjusted by simply changing the frequency that the injector opens and closes and/or the duration the injector is open by means of a digital control system.

Another alternative control strategy for an injector 10 is to use mechanical style injectors, and a system of control valves or distributors to alternate zones where fluid injection is “on” and “off” in a cyclical manner. For example, if the injection system consists of twelve injectors, it would be possible to alternate between “groups” of six injectors, for example, by means of control valves. It may be advantageous to target specific areas in the press with more fluid than other areas which would be possible by increasing the amount of time a group of injectors is “on” by allowing the valve to remain open longer.

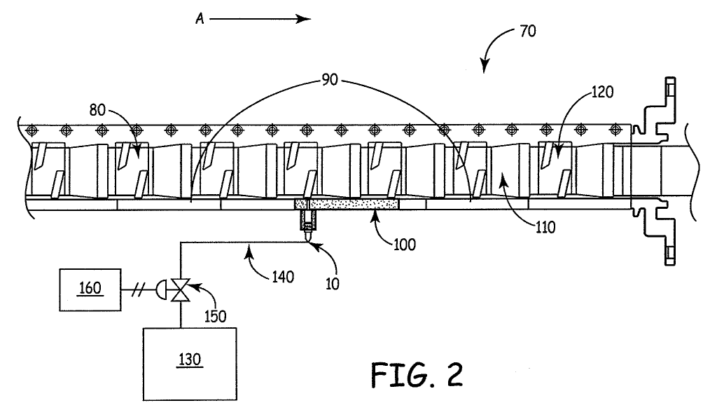

FIG. 2 is a schematic of a system in accordance with embodiments of the invention. The system includes a screw press 70 having a shaft 80 and a cage 90. The system also includes an injector 10. In the embodiment shown in FIG. 2, the injector is installed in injection ring 100, although it should be understood that the injector 10 can be installed on the press 70 in any way that allows the injector 10 to provide fluid to the press 70.

The shaft 80 rotates within the cage 90 to alternatively propel and press the material as it passes through the press in the direction indicated by arrow A. The pressing cone 110 of the shaft 80 has an increasing diameter in the direction of material flow. This creates a smaller cross section for the material to travel through compressing the material. Alternating with the pressing cone zones 110 are the extraction zones 120. The diameter of the shaft in these extraction zones 120 is relatively smaller providing for more area between the shaft and the cage for the material being processed and thus providing “relief” from the pressure of the press. As the material moves through the press in direction A it is alternatively compressed in a pressing cone section 110 and relieved in an extraction zone section 120. In the embodiment in FIG. 2, the injector 10 is placed to inject the fluid into an extraction zone 120, although fluid could be injected at any point along the press 70.

Broadly speaking, there are two basic categories of screw press designs. These are known in the art as open cage and closed cage. In a closed cage press, the material that passes through the cage is contained within a jacket that surrounds the cage. This is sometimes referred to as a “proof-sealed” jacket. This jacket may be maintained at a specified pressure, often slightly less than the operating pressure of the press. Also, it is possible that there may be several different zones in the closed cage jacket that are operated at different pressures. For example, as you move down the length of the press, the pressure may decrease until, for example, the pressure in the last zone may be slightly higher than atmospheric. In other embodiments, the discharge or inlet of the press could be jacketed and pressurized. In an open cage press, material that leaves the press before the discharge end of the press enters an environment that is not pressure controlled and is often simply a container exposed to open atmosphere.

The system shown in FIG. 2 also includes a fluid supply tank 130 for supplying fluid to the injector 10. Fluid supply line 140 conveys fluid from the tank 130 to the injector 10. Fluid supply line 140 may include pumps, heat exchangers and other equipment necessary to convey high pressure fluids at the desired conditions. For example, if a positive displacement pump is used, pressure surges within the fluid supply line are possible. A damper having a pressure loaded piston/cylinder arrangement may mitigate these surges.

Valve 150 may be located in the supply line 140 to regulate the fluid supply to the injector 10 as discussed herein. For instance, valve 150 may be cycled to open and close and the frequency and duration of these cycles can be controlled via a programmable logic controller (PLC) 160 or other means to provide for control of the amount of fluid fed to the injector 10 over a period of time. In embodiments with more than one injector or injectors located in multiple zones of the press, valves 150 may be located in the supply lines to each injector or relevant group of injectors and used to control how much fluid goes to each injector or group pre period of time. In embodiments where the injectors are electronically actuated, valves may be omitted from the system and the PLC or other controller can directly control the injector in much the same way as just described.

In one embodiment, a PLC can be programmed to inject a certain amount of fluid based on the RPM of the press shaft. A signal from an RPM sensor is sent to the PLC 160. If the RPM of the press screw increases, the PLC will send a signal to the valve 150 to increase the amount of fluid injected to adjust for the increased demand of the higher press speed. Of course manual override of any automatic system is possible and control schemes consistent with embodiments of the invention but not specifically disclosed here will occur to those of ordinary skill in the art.

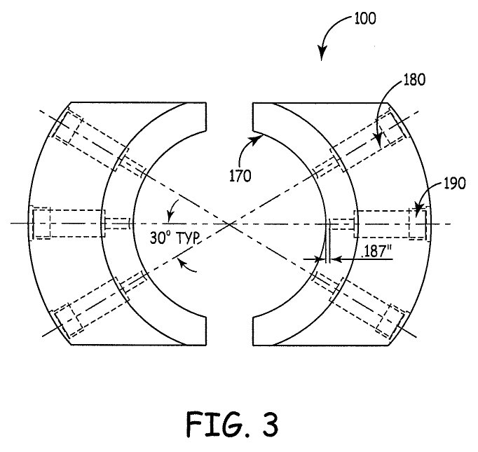

FIG. 3 is a cross section of a injection ring in accordance with embodiments of the invention. Injection ring 100 may be constructed in two parts and then fastened together and sealed. In an exemplary embodiment, the injection ring 100 may take the place of a section of cage 90 in a press 70. The inner surface 170 of the ring may be configure to be coextensive with adjacent section of the cage 90. The embodiment of the injection ring of FIG. 3 includes six ports 180 into which injectors 10 may be installed. Each port 180 has a tapped and threaded region 190 that interfaces with the threaded region 40 of the injector 10 to secure the injector 10 in the injection ring 100 (See FIG. 1). The embodiment of FIG. 3 has two essentially horizontal ports 180 opposite each other. The other four ports in this embodiment are oriented approximately thirty degrees either side of these two horizontal ports 180. All of the ports of this embodiment point essentially at the center of the injection ring 100 as installed in the press 70.

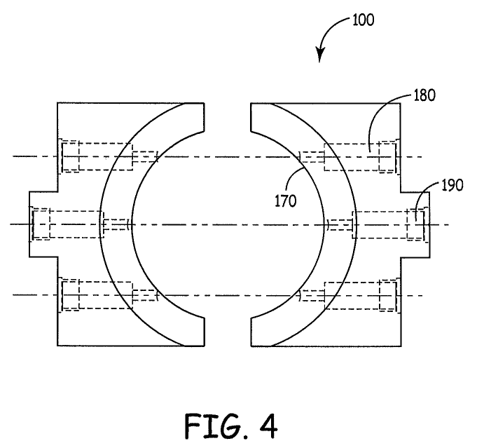

FIG. 4 is a cross section of a injection ring in accordance with embodiments of the invention. In this embodiment of an injection ring 100, there are also six ports 180. As in the embodiment in FIG. 3, there are two opposing horizontal ports 180 at the center of the ring 100. In this embodiment however, the other four ports 180 are also oriented horizontally, one above and one below each central port 180. This ring configuration allows for relatively even distribution of fluid within the press and may allow for easier access to the ports for installation, maintenance, and replacement of the injectors 10. An infinite variety of port orientations and ways to install injectors in a press will occur to one of skill in the art upon reading this disclosure, and the particular designs disclosed are merely exemplary.

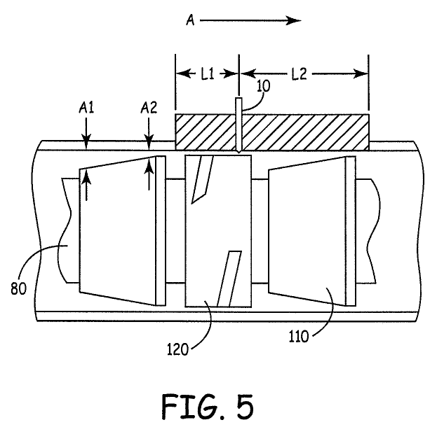

FIG. 5 is a schematic cross section of a system in accordance with embodiments of the invention. The embodiment of FIG. 5 includes a screw press 70 having a shaft 80 and a cage 90. The system also includes an injector 10. In the embodiment shown in FIG. 5, the injector is installed in injection ring 100. Material to be pressed passes through the press 70 in the direction indicated by arrow A. Injection ring 100 has a length L1 “upstream” of the injector and a length L2 “downstream” of the injector 10.

The shaft 80 rotates within the cage 90 to alternatively propel and press the material as it passes through the press in the direction indicated by arrow A. The pressing cone 110 of the shaft 80 has an increasing diameter in the direction of material flow. This creates a smaller cross section for the material to travel through compressing the material. The cross-sectional area at the start of a compression zone is referred to as A1 and the cross-sectional area the end of a compression zone is referred to as A2. The cross sections are actually annular areas with a constant outer diameter and an increasing inner diameter that reduces the area of the annulus. The compression ratio for a compression zone can be expressed as A2/A1. Because the second area A2 is smaller than the first area A1, this number will be below 1.0. As the material moves through the press in direction A it is alternatively compressed in a pressing cone section 110 and relieved in an extraction zone section 120. In the embodiment in FIG. 5, the injector 10 is placed to inject the fluid into an extraction zone 120, although fluid could be injected at any point along the press 70.

In open caged presses where fluid and extracted liquid is expelled through the cage 90 throughout the length of the cage, it has always been thought that maximizing the area available for liquids to pass through, often called deoiling area, provided the best performance for the press. The practical limitation for maximizing deoiling area has been passage of unwanted solid material through the cage if, for example, cage lining bars were spaced too far apart. It was unexpectedly discovered that sacrificing deoiling area for injection ring length is advantageous because it allows for control of the dispersion of injected fluid into the press material without excessive losses of injected fluid from adjacent deoiling areas. For instance, increasing the length L1 upstream of the injector 10 provides for containment of the fluid to the extent that it may migrate upstream and escape that provides for superior press performance despite the loss of deoiling area. Also, increasing the length of the ring L2 downstream from the injector 10 provides for superior retention of the injected fluid and ultimately superior extraction despite the loss of deoiling area.

The optimal length of the injection ring (L1+L2) and the optimal upstream L1 and downstream lengths L2 are related to other press parameters. Screw presses have a feed worm on the upstream end of the main shaft 80 to convey feed into the working portion of the press. This is not to be confused with a feed screw separate from the main shaft 80 that may convey material to the press from a storage or other facility. For the purposes of this discussion, the diameter of the unflighted portion of such a feed worm is defined as D. It has been discovered that injection rings having an downstream length L2 of less than twice the diameter of the unflighted portion of the feed worm D do not provide adequate retention of injected fluid, and that lengthening the injection ring to this minimum length unexpectedly improves press performance despite the loss of deoiling area.

The optimal length of the upstream portion L1 of the injection ring is also related to the diameter D as defined above. The optimal L1 is between D and 1.5*D. Larger upstream ring lengths L1 do not improve press performance and unnecessarily reduce deoiling area, while shorter ring lengths allow for upstream migration and loss of injected fluid and poorer press performance despite the additional deoiling area. The optimal ring length within this range can be further defined with reference to the compression ratio in the compression zone 110 immediately upstream of the injector 10. This is true because a greater compression of the material upstream of the injection point reduces the potential for upstream migration of injected fluid. Considering the compression ratio, the optimal upstream ring length may be represented by the expression L1=0.5*(A2/A1*D)+D.

It was also unexpectedly discovered that injection rings are optimally placed downstream in a multicompression zone press. Prior belief was that injection of the fluid should take place at the start of the working section of the press to give the fluid a greater time to contact the material being pressed. It has been learned that it is advantageous to position the ring or rings such that there is sufficient compression and slight deoiling prior to the injection of the fluid. If the overall length of the working section of the press from the first extraction zone 120 to the last compression zone 110 is defined as PL or press length, the optimal placement of a single ring is between 0.25*PL and 0.50*PL from the inlet end of the working zone. A second ring, if applicable, should be placed between 0.25*PL and 0.35*PL downstream from the first ring so that there is sufficient deoiling downstream of the second ring and between the two rings.

While preferred embodiments of the present invention have been described, it should be understood that various changes, adaptations and modifications may be made therein without departing from the spirit of the invention and the scope of the appended claims.

What is claimed is:

1. An apparatus comprising:
a. a screw press having a shaft and cage;
b. an injector for injecting fluid into the press, the injector having a mechanical limiter that opens to allow fluid through the injector when a fluid supply pressure to the injector exceeds a first threshold level and closes when the fluid supply pressure to the injector is below a second threshold level.

2. The apparatus of claim 1, wherein the first and second threshold pressure levels are the same.

3. The apparatus of claim 1, wherein the injector is installed in an injection ring.

4. The apparatus of claim 3, wherein there are four injectors installed in the injection ring.

5. The apparatus of claim 4, wherein the four injectors are spaced circumferentially around the injection ring.

6. The apparatus of claim 1, wherein the screw press comprises at least one extraction zone and the injector is configured to inject fluid into the reaction zone.

7. The apparatus of claim 1, wherein the fluid comprises a coolant.

8. The apparatus of claim 1, wherein the injector has a conduit for passing fluid through and the cross-sectional area of the conduit is selected to provide for a predetermined volumetric flow rate of fluid at a predetermined fluid supply pressure.

9. The apparatus of claim 1, wherein the fluid comprises a solvent.

10. The apparatus of claim 1, wherein the fluid is injected at near-supercritical conditions.

11. The apparatus of claim 10, wherein the fluid comprises carbon dioxide

12. An apparatus comprising:
a. a screw press having a shaft and cage;
b. an injector for injecting fluid into the press, the injector comprising an electrically operated actuator that opens to allow fluid through the injector and closes to restrict fluid flow through the injector.

13. The apparatus of claim 12, wherein the actuator is biased to reset to a closed position in the absence of an electrical signal.

14. The apparatus of claim 12, wherein the flow rate through the injector is regulated by a digital control system that adjusts the frequency that the actuator opens and closes.

15. The apparatus of claim 12, wherein the flow rate through the injector is regulated by a digital control system that adjusts the duration that the actuator is open and closed.

16. A system for extracting oil from oil-bearing solids, the system comprising:
a. a screw press having a cage and a shaft, the shaft including a feed worm section;
b. an injection ring with an injector installed thereon, the injection ring having a length upstream of the injector of between 1.0 and 1.5 times the unflighted diameter of the feed worm section of the shaft.

17. The system of claim 16, wherein the length of the injection ring upstream of the injector is defined by the equation L1=D+0.5*(A2/A1*D), wherein;
a. L1 is the length of the injection ring upstream of the injector;
b. D is the unflighted diameter of the feed worm section of the shaft;
c. A1 is the cross sectional area of the space between the shaft and the cage at the beginning of a compression zone immediately upstream of the injector; and
d. A2 is the cross sectional area of the space between the shaft and the cage at the end of a compression zone immediately upstream of the injector.

18. The system of claim 16, wherein the length of the injection ring downstream of the injector is at least two times the unflighted diameter of the feed worm section of the shaft.

19. The system of claim 16, wherein the press has a working length defined as the distance between a first extraction zone and a last compression zone and the injection ring is located such that the injector is between 0.25 and 0.50 times this length from the first extraction zone downstream on the press.

20. The system of claim 19, wherein a second injection ring with a second injector thereon is located such that the second injector is between 0.25 and 0.35 times the working length of the press downstream of the first injector.
